(19) United States
(12) Patent Application Publication
(10) Pub. No.: US 2026/0370673 A1
(43) Pub. Date: Nov. 19, 2026

(54) AUTOMATED ASSET-TAGGING AND FINGERPRINTING FOR AUTONOMOUS PENTESTING

(71) Applicant: Horizon 3 AI, Inc., Dover, DE (US)

(72) Inventors: Robert George Alderman, Lafayette, CO (US); Levi Dyrek Payne, Woodlawn, VA (US); Chad Glinsky, Boulder, CO (US); John Esser Dodson, New York, NY (US); Anton J. Foltz, Omaha, NE (US)

(21) Appl. No.: 19/208,376

(22) Filed: May 14, 2025

(51) Int. Cl. H04L 9/40; H04L 41/16

(52) U.S. Cl. CPC H04L 63/1433; H04L 41/16; H04L 63/1425

(57) ABSTRACT

An autonomous pentesting agent may perform baseline pentesting operations of a base set of pentesting operations during an autonomous pentest of a network. The agent may obtain, during the autonomous pentest, information associated with a network asset of the network based on the baseline pentesting operations. The agent may classify the network asset as a first asset type based on the information obtained during the autonomous pentest and on a mapping between asset types and fingerprints, where each fingerprint includes fingerprint information specific to a respective asset type obtained via at least one baseline pentesting operation of the base set of pentesting operations. The agent may perform, during the autonomous pentest, additional pentesting operations of a set of pentesting operations specific to the first asset type and different from the base set of pentesting operations, where the additional pentesting operations target security vulnerabilities associated with the first asset type.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support automated network asset classification in autonomous pentesting.

In some aspects, the techniques described herein relate to a method for autonomous pentesting using network asset classifications including: performing, during an autonomous pentest of a network including a plurality of network assets, one or more baseline pentesting operations selected from a base set of autonomous pentesting operations; obtaining, during the autonomous pentest, information associated with a network asset of the plurality of network assets based at least in part on the one or more baseline pentesting operations; classifying the network asset as a first asset type based at least in part on the information obtained during the autonomous pentest and on a mapping between a plurality of asset types and a plurality of fingerprints, wherein each fingerprint of the plurality of fingerprints includes fingerprint information specific to a respective asset type and obtained via at least one baseline pentesting operation of the base set of autonomous pentesting operations; and performing, during the autonomous pentest of the network, one or more additional pentesting operations selected from a set of autonomous pentesting operations specific to the first asset type and different from the base set of autonomous pentesting operations, wherein the one or more additional pentesting operations target one or more security vulnerabilities associated with the first asset type.

In some aspects, the techniques described herein relate to an apparatus for autonomous pentesting using network asset classifications, including: one or more memories storing processor-executable code; and one or more processors coupled with the one or more memories and individually or collectively operable to execute the code to cause the apparatus to: perform, during an autonomous pentest of a network including a plurality of network assets, one or more baseline pentesting operations selected from a base set of autonomous pentesting operations; obtain, during the autonomous pentest, information associated with a network asset of the plurality of network assets based at least in part on the one or more baseline pentesting operations; classify the network asset as a first asset type based at least in part on the information obtained during the autonomous pentest and on a mapping between a plurality of asset types and a plurality of fingerprints, wherein each fingerprint of the plurality of fingerprints includes fingerprint information specific to a respective asset type and obtained via at least one baseline pentesting operation of the base set of autonomous pentesting operations; and perform, during the autonomous pentest of the network, one or more additional pentesting operations selected from a set of autonomous pentesting operations specific to the first asset type and different from the base set of autonomous pentesting operations, wherein the one or more additional pentesting operations target one or more security vulnerabilities associated with the first asset type.

In some aspects, the techniques described herein relate to a non-transitory computer-readable medium storing code for autonomous pentesting using network asset classifications, the code including instructions executable by one or more processors to: perform, during an autonomous pentest of a network including a plurality of network assets, one or more baseline pentesting operations selected from a base set of autonomous pentesting operations; obtain, during the autonomous pentest, information associated with a network asset of the plurality of network assets based at least in part on the one or more baseline pentesting operations; classify the network asset as a first asset type based at least in part on the information obtained during the autonomous pentest and on a mapping between a plurality of asset types and a plurality of fingerprints, wherein each fingerprint of the plurality of fingerprints includes fingerprint information specific to a respective asset type and obtained via at least one baseline pentesting operation of the base set of autonomous pentesting operations; and perform, during the autonomous pentest of the network, one or more additional pentesting operations selected from a set of autonomous pentesting operations specific to the first asset type and different from the base set of autonomous pentesting operations, wherein the one or more additional pentesting operations target one or more security vulnerabilities associated with the first asset type.

### BRIEF DESCRIPTION OF THE DRAWINGS

FIG. 1 shows an example of a computing environment that supports automated network asset classification in autonomous pentesting in accordance with aspects of the present disclosure.

FIG. 2 shows an example of an autonomous pentest map that supports automated network asset classification in autonomous pentesting in accordance with aspects of the present disclosure.

FIGS. 3 through 5 show examples of computing environments that support automated network asset classification in autonomous pentesting in accordance with aspects of the present disclosure.

FIG. 6 shows a diagram of a system including a device that supports automated network asset classification in autonomous pentesting in accordance with aspects of the present disclosure.

FIG. 7 shows a flowchart illustrating methods that support automated network asset classification in autonomous pentesting in accordance with aspects of the present disclosure.

### DETAILED DESCRIPTION

A pentesting service may perform a base set of pentesting operations during a pentest on a target network. For example, the pentesting service may perform pentesting operations that target services, applications, or vulnerabilities commonly present across a large quantity of networks. The base set may include standard, default, or initial operations typically performed as part of pentest. In some cases, however, pentests performed using the base set of pentesting operations may not comprehensively identify vulnerabilities of the target network. That is, network assets of the target network may include services or assets that are uncommon across networks and thus may be associated with vulnerabilities that are less common or are specific to an asset type that is less common across networks, and such vulnerabilities may go undetected if only the base set of pentesting operations are performed. Stated differently, the pentesting service may fail to identify exploits that are uncommon or fall outside the scope of the base set of pentesting operations, and these types of exploits may be referred to as “long tail” exploits.

In some cases, the pentesting service may classify network assets into asset types. The pentesting service may use this classification to identify exploits that are specific to the asset type. However, classification may be time-consuming and error-prone, which may increase the time spent to run the pentest, decrease the accuracy of the results of the pentest, or both. For example, the pentesting service may scan a target network to gather information about various network assets, including Hypertext Transfer Protocol (HTTP) headers, Hypertext Markup Language (HTML) response data, and/or version strings. The pentesting service or a user associated with the pentesting service may manually map each network asset to an asset type (e.g., a device type, an application, a service, etc.) based on the gathered information and on a human-generated set of signature rules or regular expressions (RegExes) mapped to different asset types. However, creating and maintaining an updated version of information indicative of an asset type may be difficult, and the pentesting service may use signature rules or RegExes that are incomplete or outdated. In such cases, the pentesting service may not accurately classify, or fail to classify, network assets into asset types. Additionally, manually classifying the network assets into asset types may be labor-intensive, particularly if done by a user associated with the pentesting service, and may involve a relatively large amount of time. Pausing a pentest to classify network assets and identify asset type-specific exploits may delay completion of a pentest and, accordingly, delay remediation of vulnerabilities identified during the pentest.

An autonomous pentesting agent described herein may autonomously classify network assets and perform asset type-specific exploits based on the autonomous classification. For example, the autonomous pentesting agent may perform a base set (e.g., standard, initial, or default set) of autonomous pentesting operations to obtain information associated with network assets of a target network during an autonomous pentest, including HTTP headers, HTML response data, version strings, or the like. The autonomous pentesting agent may match the obtained information to stored fingerprints mapped to different asset types. Specifically, the autonomous pentesting agent may use one or more artificial intelligence (AI) models, such as one or more large language models (LLMs), and/or one or more open-source tools to maintain up-to-date and accurate fingerprints corresponding to different asset types. Additionally, the autonomous pentesting agent may store exploits corresponding to each asset type. That is, the autonomous pentesting agent may develop and store asset type-specific exploits, which may be used to perform more comprehensive and efficient subsequent pentests. For example, the autonomous pentesting agent may classify a network asset as a first asset type and use one or more exploits corresponding to the first asset type during the autonomous pentest, enabling the autonomous pentesting agent to identify a wider, more comprehensive range of vulnerabilities, such as vulnerabilities exposed via the base set of autonomous pentesting operations and vulnerabilities exposed via asset type-specific exploits.

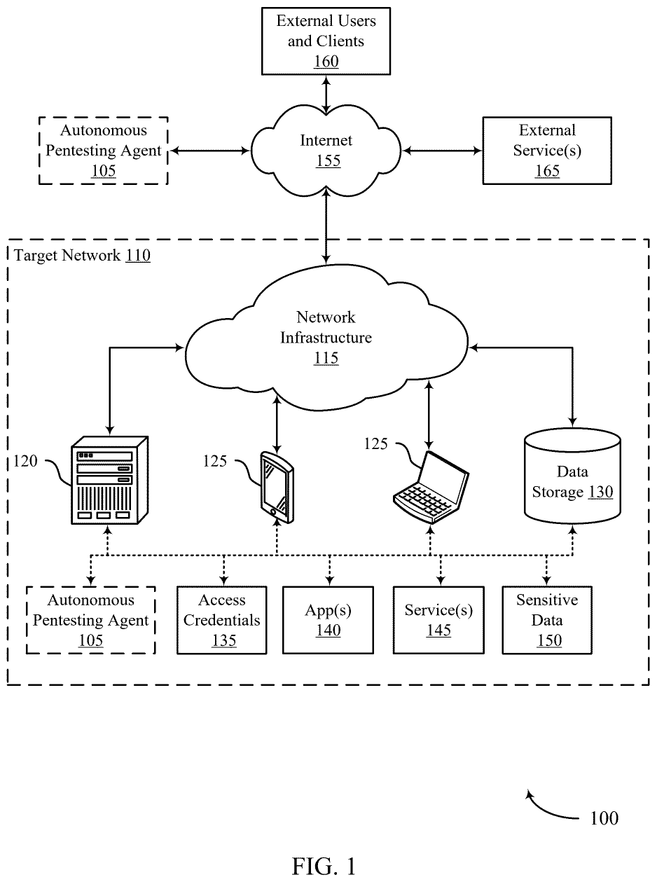

FIG. 1 illustrates an example of a computing environment 100 that supports automated network asset classification in autonomous pentesting in accordance with aspects of the present disclosure. The computing environment 100 may include an autonomous pentesting agent 105 that performs an autonomous pentest of a target network 110. The target network 110 may include one or more devices or systems, such as a network infrastructure 115, server 120, computing devices 125, data storage 130, or any combination thereof. The devices or systems of the target network 110 may be configured to access or provide various network information and services, such as access credentials 135, app(s) 140, service(s) 145, sensitive data 150, or any combination thereof.

The target network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the target network 110 as well as communication between the target network 110 (e.g., the private network) and the Internet 155 or other external network (outside the target network 110, beyond a firewall associated with the target network 110, etc.). The target network 110 may include aspects of one or more wired networks, one or more wireless networks (e.g., cellular networks, Wi-Fi networks), or any combination thereof. The target network 110 may include aspects of one or more public networks or private networks, as well as secured or unsecured networks, or any combination thereof. For example, the target network 110 may be an example of a private network that includes one or more public-facing or external assets that are accessible via the Internet 155. As an example, the Internet 155 may refer to the world wide web, and users (e.g., external users and clients 160), may access the target network 110 via the Internet 155 through a website or application that is accessible or available via the Internet 155. For instance, the external users and clients 160, the external service(s) 165, or both may access network information and services via the Internet 155, including the access credentials 135, app(s) 140, service(s) 145, and sensitive data 150.

The target network 110 may be, or may be part of, a domain, such as a private domain associated with an organization, company, client, business, etc., defining an administrative boundary of the target network 110. The domain may include components such as computing devices 125, the server 120, etc., along with associated users (e.g., access credentials 135) and service(s) 145 that are governed or configured by one or more domain controllers and operate in accordance with policies that are put in place and managed by the one or more domain controllers. The domain may be divided into multiple subdomains or groups containing respective subsets of components, users (e.g., access credentials 135), and service(s) 145 that operate in accordance with a respective policy (e.g., group policy).

The target network 110 may be accessible via one or more hosts. For example, hosts may be examples of real or virtual machines that are connected to and capable of accessing the target network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the target network 110 and outside of the network (e.g., with devices accessible via the Internet 155). For example, the server 120 may send data to and receive data from one or more of the computing devices 125. Additionally, or alternatively, hosts may access resources of the target network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the target network 110, including data, software, and hardware. In some examples, network assets may refer to machines that include network shares. For example, network assets may be examples of machines (e.g., real or virtual machines) that include shares of the target network 110, such as file sharing systems. Network assets may be obtained and utilized by attackers to compromise the target network 110. In some cases, network assets may refer to network entities (e.g., system hosts or machines) that have internet protocol (IP) addresses and may be discovered during scans. The server 120, the computing devices 125 (e.g., laptops, desktops, mobile devices, smart vehicles, wearables), the data storage 130, and the access credentials 135, app(s) 140, service(s) 145, cookies, encryption and decryption keys, tokens, and sensitive data 150 accessible via the devices and systems of the target network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage) and systems may be considered network assets as well as information, apps, and services accessible through physical devices and systems of the target network 110.

Hosts may store, provide, or implement access credentials 135, app(s) 140, service(s) 145, sensitive data 150, or any combination thereof. In some cases, computing devices 125 on the network may access the one or more network assets (credentials 135, app(s) 140, service(s) 145, sensitive data 150, etc.) via the server 120 (e.g., via a host). Additionally, or alternatively, computing devices 125 may locally store or otherwise access one or more network assets of the target network 110. For example, users of the target network 110 may access app(s) 140 and service(s) 145 via the computing devices 125 directly or indirectly (e.g., via a connection between the computing devices 125 and the server 120).

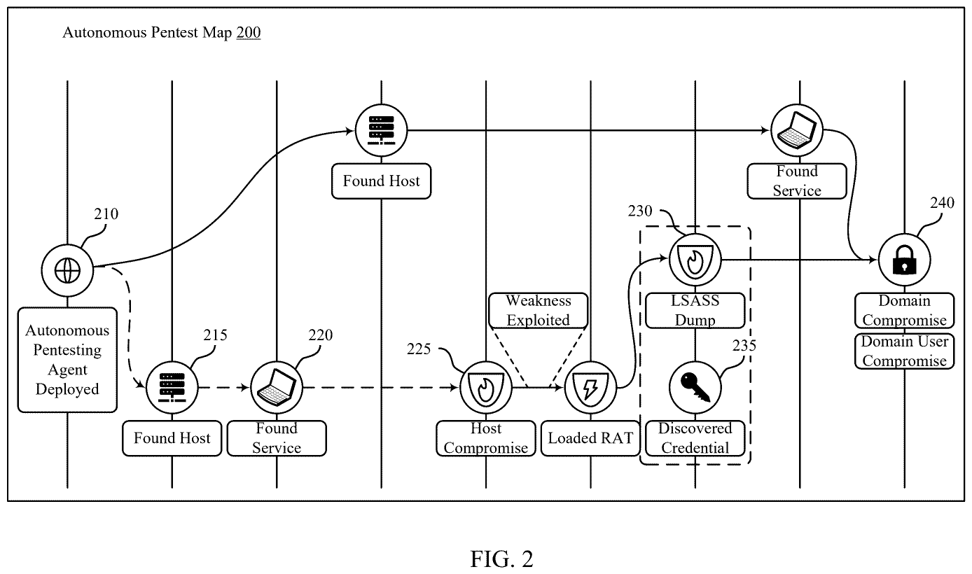

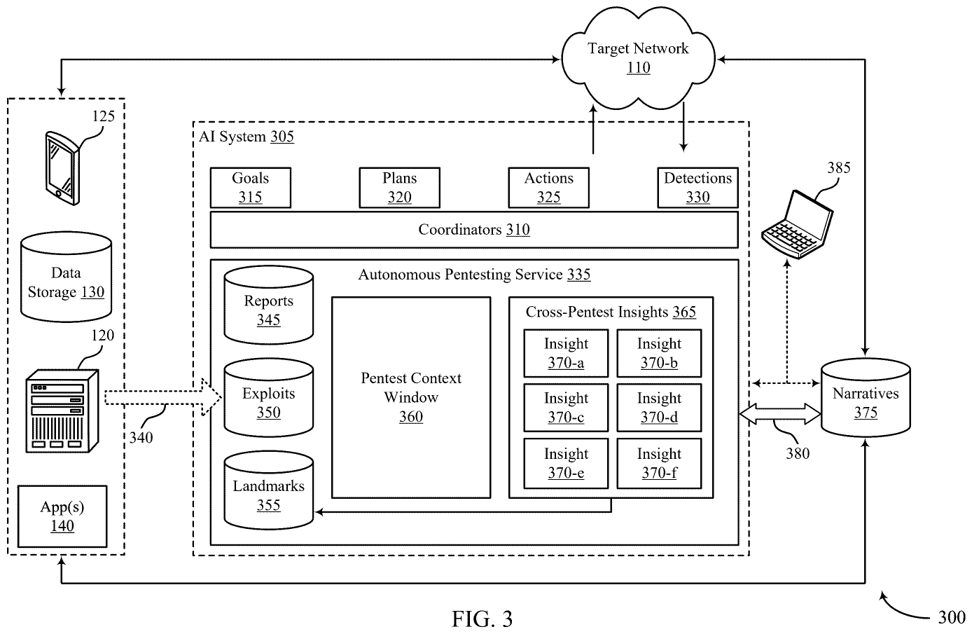

The autonomous pentesting agent 105 may perform a pentest of the target network 110. As used herein, a penetration test or a “pentest” may refer to the performance of one or more security operations that simulate a cybersecurity attack in order to identify vulnerabilities in the target network 110. The autonomous pentesting agent 105 may perform the pentest of the target network 110 using one or more AI models. For example, the autonomous pentesting agent 105 may be “autonomous” in that the autonomous pentesting agent 105 may perform the pentest without hard-coding (e.g., deterministic coding), user inputs, or the like and, instead, by using the one or more AI models. The autonomous pentesting agent 105 may identify, via the pentest, security vulnerabilities of the target network 110. An example of an output of the pentest may be described in greater detail elsewhere herein, including with reference to FIGS. 2 and 3.

The autonomous pentesting agent 105 may, via the one or more AI models, determine and implement an attack path for a pentest. For example, the autonomous pentesting agent 105 may identify or select an asset of the target network 110 to attempt to access initially and, from that asset, another asset to attempt to access, and so on. In other words, the autonomous pentesting agent 105 may use the one or more AI models to generate (e.g., output) decisions or operations that mimic those of a potential cyber attacker. The one or more AI models may output a targeted asset of the target network 110 to be subject to an access attempt by the autonomous pentesting agent 105 based on inputs and relevant context of various assets in the target network 110. For instance, the one or more AI models may output targeted assets based on the relative position of assets within the target network 110, asset types, downstream assets (e.g., accessible after or through accessing a targeted asset), or the like.

The one or more AI models may be trained or augmented using data of previous pentests of the target network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the target network 110 previously, on other networks, or both. The autonomous pentesting agent 105 may perform improved pentests after the one or more AI models are trained or augmented using previous pentests of the target network 110. That is, as the autonomous pentesting agent 105 learns more about the target network 110, the autonomous pentesting agent 105 may perform pentests with higher performance levels (higher accuracy, higher quantities of potential attack paths, etc.).

In some cases, the pentest may be initiated internal (e.g., within) or external to (e.g., outside of a firewall) the target network 110. For example, the autonomous pentesting agent 105 may be deployed at a host device of the target network 110 (e.g., deployed to the server 120 or computing devices 125). In such cases, the autonomous pentesting agent 105 may perform the pentest as an internal user of the target network 110. Such internal pentests may be indicative of or emulate internal security threats to the network, such as from employees of an organization or an attacker that has otherwise access to the target network 110 internally or to a user of the target network 110. Alternatively, the autonomous pentesting agent 105 may be deployed at the Internet 155. For example, the autonomous pentesting agent 105 may perform the pentest as an external user of the target network 110, such as by accessing external or public-facing assets of the target network 110 on the Internet 155. In some examples, the autonomous pentesting agent 105 may be deployed via a runner. For example, a runner may be an executable process, script, or sequence, which enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105 (such as in accordance with a pentest schedule).

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the target network 110 against cybersecurity attacks relative to hard-coded (e.g., deterministic) or manual (e.g., human operated) pentests.

As described herein, the autonomous pentesting agent 105 may classify network assets of the target network 110 and perform exploits specific to asset types of the network assets. For example, the autonomous pentesting agent 105 may perform one or more operations of a base set of autonomous pentesting operations and obtain information associated with a network asset of the target network 110. Using the information, the autonomous pentesting agent 105 may classify the network asset as an asset type. For example, the autonomous pentesting agent 105 may compare the information to multiple fingerprints mapped to respective asset types. The autonomous pentesting agent 105 may use exploits corresponding to the asset type in subsequent pentesting operations. That is, the autonomous pentesting agent 105 may perform additional pentesting operations specific to the asset type and different from the base set of pentesting operations.

By autonomously classifying the network asset and performing asset type-specific exploits, the autonomous pentesting agent 105 may expand the coverage of the autonomous pentest (compared to an autonomous pentest that does not involve asset type-specific exploits). For example, the autonomous pentesting agent 105 may autonomously classify network assets into asset types, enabling classification of network assets to be used during an autonomous pentest with minimal delay as compared to manual classification of the network assets. That is, because the autonomous pentesting agent 105 classifies network assets relatively quickly, the autonomous pentesting agent 105 may use asset type-specific exploits during the autonomous pentest. By performing asset type-specific exploits, the autonomous pentesting agent 105 may identify weaknesses and vulnerabilities of network assets that may otherwise not be identified or addressed (e.g., not be identified or addressed via a pentest including only the base set of pentesting operations and/or a pentest that does not include classification). Additionally, the autonomous pentesting agent 105 may classify network assets with improved accuracy by using one or more AI models (e.g., one or more LLMs or agentic workflows) and continuously updating fingerprints of asset types with updated information obtained during pentesting and/or via open-source tools. A record of up-to-date and accurate fingerprints of asset types may not be maintained by a human pentester or security team, as such maintenance may be resource-intensive and delay pentesting operations. Specifically, when an exploit emerges (e.g., is disclosed publicly), attackers may quickly attempt to perform the exploit on publicly-facing network assets (e.g., endpoints). However, defensive operations by the target network 110 may be slower than these exploit attempts when security teams manually monitor for and patch emerging exploits. Accordingly, the autonomous pentesting agent 105 described herein, by using the one or more AI models, may identify and patch exploits more quickly, thereby reducing an amount of time when network assets are vulnerable to attack.

As used herein, an asset type may correspond to a specific application, service, device, system role, or platform identifiable from information obtained during a pentest (e.g., HTTP headers, HTML titles, version strings, or other metadata), as well as information from one or more open-source tools. An asset type may be indicative of the operational function or technical configuration of a network asset within the target network 110, and the asset type may be used to select corresponding exploits. For example, the autonomous pentesting agent may select an asset type-specific exploit that targets a vulnerability of a particular network asset type. That is, the exploit may be based on the operational function or technical configuration of the network asset.

FIG. 2 shows an example of an autonomous pentest map 200 that supports automated network asset classification in autonomous pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the target network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the target network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support more comprehensive vulnerability identification by performing autonomous network asset classification. For example, the autonomous pentesting service may, after the host identification 215 event, classify the host. As an example, the autonomous pentesting service may identify and classify a function (e.g., assign one or more functional classifications) of the host within the target network. The function may be indicative of an operational context of the host within the target network and may inform subsequent pentesting operations. That is, the autonomous pentesting service may perform one or more pentesting operations specific to the function of the host within the target network to achieve the host compromise 225 event.

FIG. 3 shows an example of a computing environment 300 that supports automated network asset classification in autonomous pentesting in accordance with aspects of the present disclosure. The computing environment 300 may implement or be implemented by the computing environment 100, the autonomous pentest map 200, or both. For example, the computing environment 300 may include servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions (e.g., from the perspective of a potential cyber attacker). In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing and may be used by the AI system 305. In some examples, the AI system 305 may utilize an LLM which utilizes a neural network architecture to process, understand, and generate natural language. For example, LLMs may be trained or augmented on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously (e.g., through the use of AI agents), at least for some operations, to achieve specified goals, make decisions, and take actions without direct human intervention. In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may include an autonomous pentesting service 335 and may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a target network 110, compromise (such as by obtaining unauthorized access or deploying unauthorized software to) a domain or a network asset of the target network 110, or any combination thereof. To obtain the goals 315, the AI system 305 may generate one or more plans 320 that are based on actions 325 and detections 330. For example, to determine a next action within a defined set of guardrails or instructions, the AI system 305 may generate a plan 320 that can include an action 325 to invoke (e.g., execute) one or more commands on a target network 110 to obtain a detection 330 from the target network 110.

In some examples, the target network 110 may include one or more network assets such as servers 120, computing devices 125, data storages 130, app(s) 140, or any combination thereof. Further, obtaining a detection 330 from the target network 110 may include the AI system 305 retrieving telemetry data from the one or more network assets of the target network 110. In some cases, telemetry data obtained from the target network 110 may include logs, traces, metrics, events, or any combination thereof from the one or more network assets of the target network 110. For example, a detection 330 may include some data that is obtained from the target network 110 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 110, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, billions, or trillions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 that resulted in the action 325 succeeding or failing, or any combination thereof. Therefore, the AI system 305 may continuously obtain and update the training data used for training AI/ML models and perform reinforcement learning using collective intelligence to improve the weights and training of the AI/ML models.

In some examples, the training data for the AI system 305 may include telemetry data obtained from the target network 110, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 110) to assist the AI system 305 to navigate and map an environment of the target network 110 during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by providing the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 110, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentesting operations, including successfully exploited vulnerabilities, accessed systems and data, attempted but failed exploit paths, attack paths, among others.

The AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in software (e.g., commonly used enterprise or commercial software). In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant compromise of the target network 110. Therefore, the cross-pentest insights 365 may indicate one or more insights 370 that represent patterns and vulnerabilities that occur across different networks and testing scenarios, helping organizations better understand systemic security weaknesses and how to address such weaknesses. For example, the cross-pentest insights 365 may be added as landmarks 355 for further training the AI system 305 to perform autonomous pentests.

The cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a target network 110. In another example, a narrative 375 may be a presentation for a company or organization that indicates the one or more vulnerabilities in a target network 110 associated with the company or organization. For example, the presentation can indicate the cross-pentest insights 365 obtained from performing one or more autonomous pentests on the target network 110 associated with the company or organization (e.g., the target network 110).

In some examples, users or devices external to the target network 110 may interact, communicate, or otherwise engage with the AI system 305 to configure pentesting parameters, perform pentesting operations on the target network 110, or analyze the results from a pentest on target network 110. For instance, a user such as a service provider for the AI system 305 may operate an external device 385 to provide information to the AI system 305 (e.g., to the coordinators 310), which identifies goals 315, plans 320, or actions 325 for pentesting the target network 110. Additionally, or alternatively, the AI system 305 may provide information, such as cross-pentest insights 365, to the external device 385. A user of the external device 385 may analyze the cross-pentest insights 365 to generate or modify narratives 375 corresponding to the results of the pentest on the target network 110. In some cases, an output of the LLM used to generate narratives 375 may be sent to the external device 385, and a user (e.g., a service provider) of the external device 385 may aggregate narratives 375 about the target network 110 for reporting or conveyance via the pentest context window 360. Alternatively, the user of the external device 385 may modify one or more narratives 375 based on goals 315, plans 320, detections 330, or other information such that the narratives 375 resulting from the pentest for the target network indicate the relevant and important information for identifying weaknesses and addressing vulnerabilities in the target network 110.

An autonomous pentesting service may utilize the AI system 305 to classify network assets as asset types and/or maintain fingerprints corresponding to different asset types. For example, the autonomous pentesting service may utilize the AI system 305 (or one or more LLMs of the AI system 305) to identify patterns or RegExes within information associated with a network asset obtained via a base set of pentesting operations. The AI system 305 may match the identified patterns or RegExes with fingerprints of network assets previously generated and stored (e.g., prior to the pentest or during earlier pentests). In such examples, the AI system 305 may use context (e.g., via one or more LLMs) of the network asset to improve a confidence level of the matching (e.g., network asset type classification), such as compared to manual or automated matching. Alternatively, the AI system 305 may generate a new fingerprint if the AI system 305 is unable to match the identified patterns or RegExes with existing fingerprints. In some examples, the AI system 305 may augment the new fingerprint with information from one or more open-source tools (e.g., Shodan). The AI system 305 may continuously update one or more fingerprints during pentesting and between pentests (e.g., offline and online), which may improve the ability of the autonomous pentesting service to classify network assets. As used herein, a fingerprint may refer to a data structure or record that includes one or more attributes or patterns associated with a particular asset type. For example, a fingerprint may include a combination of indicators such as HTTP header values, HTML titles, version strings, hash values (e.g., body hash, favorite icon (favicon) hash, etc.), and other metadata that, when detected together on a network asset, are indicative of a specific asset type. An asset type may refer to a function of a network asset and/or a product, vendor, and version of a network asset running on a host.

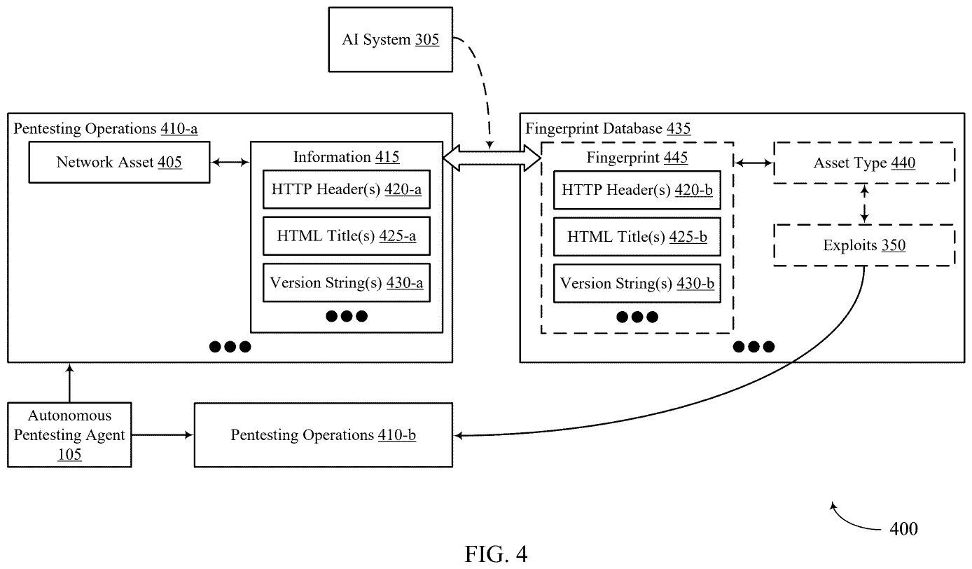

FIG. 4 shows an example of a computing environment 400 that supports automated network asset classification in autonomous pentesting in accordance with aspects of the present disclosure. The computing environment 400 may implement or be implemented by the computing environment 100, the autonomous pentest map 200, the computing environment 300, or any combination thereof. For example, the computing environment 400 may illustrate an autonomous pentest of a target network, such as the target network 110 as described with reference to FIGS. 1 and 3. An autonomous pentesting agent 105 may perform the autonomous pentest and, in some examples, may use an AI system 305 to perform network asset classification and/or fingerprint generation.

The autonomous pentesting agent 105 may perform pentesting operations 410-a during an autonomous pentest on a target network. For example, the autonomous pentesting agent 105 may perform one or more baseline pentesting operations selected from a base set (e.g., default set, initial set, etc.) of autonomous pentesting operations. The base set of pentesting operations may target network assets or vulnerabilities commonly present across a large quantity of networks and/or gather standard information prior to more specialized pentesting operations (e.g., asset type-specific pentesting operations). For example, the one or more baseline pentesting operations may include a crawl (e.g., a scan) or a banner grab of one or more network assets of the target network, including a network asset 405. The autonomous pentesting agent 105 may obtain information 415 associated with the network asset 405 based on the pentesting operations 410-a. The information 415 may include HTTP header(s) 420-a, HTML title(s) 425-a, and version string(s) 430-a based on a crawl of the network asset 405. The information 415 may also include favicon hashes (e.g., MurmurHash3 (mmh3) or MD5 hashes), favicon screenshots, HTML body hashes, Secure Sockets Layer (SSL) fingerprints (e.g., JARM or JA3 fingerprints), cookie signatures, HTTP titles, or landing-page source HTML. Additionally, or alternatively, the base set of pentesting operations may include directory brute-forcing, default credential testing, SSL and/or Transport Layer Security (TLS) misconfiguration checks, and the like.

The autonomous pentesting agent 105 may obtain the information 415 by performing IP address or hostname discovery to identify network assets of the target network, such as via network scanning, domain discovery, or Domain Name System (DNS) enumeration. For example, the autonomous pentesting agent 105 may use a tool to obtain the information 415 (e.g., a web crawler or active scanner), or the autonomous pentesting agent 105 may perform scanning and extraction of the information 415 from the network asset 405.

After identifying IP addresses or hostnames of a network asset, the autonomous pentesting agent 105 may transmit one or more HTTP requests (e.g., GET/or HEAD/ requests) to the identified network assets to retrieve information without accessing content directly. The network assets may, in response, transmit one or more HTTP responses, which may include the HTTP header(s) 420-a. The HTTP header(s) 420-a may include metadata such as server information (e.g., indicating the software or platform the network asset is running on), content-type (e.g., indicating a type of data being returned), caching policies, and security policy information.

The autonomous pentesting agent 105 may parse HTML content of the one or more HTTP responses to obtain the HTML title(s) 425-a. For example, the autonomous pentesting agent 105 may identify the HTML title(s) 425-a at a beginning of an HTML section of an HTTP response. In some examples, the autonomous pentesting agent 105 may use a scraping tool to obtain the HTML content and extract the HTML title(s) 425-a.

In some examples, the HTTP header(s) 420-a may include the version string(s) 430-a. As an example, a server header may include a version detail, such as Apache/2.4.7. Additionally, or alternatively, HTML content of the one or more HTTP responses may include the version string(s) 430-a in meta tags (e.g., <meta name=“generator” content=“WordPress 5.7”/>). In another example, the autonomous pentesting agent 105 may identify the version string(s) 430-a based on a directory traversal (e.g., in directories or files associated with a network asset), scraping HTML content, or the like.

The autonomous pentesting agent 105 may classify the network asset 405 as an asset type 440 based on the information 415 and a fingerprint 445 in a fingerprint database 435. For example, the autonomous pentesting agent 105 may match the information 415 to a fingerprint 445 of multiple fingerprints in the fingerprint database 435. The fingerprint 445 may include a combination of information that, when found together on (e.g., in an HTTP response from) a network asset, indicates the asset type 440. For example, HTTP header(s) 420-b, HTML title(s) 425-b, and version string(s) 430-b may be indicative of the asset type 440. The fingerprint database 435 may include the fingerprint 445 based on one or more pentests prior to the pentest in which the pentesting operations 410-a were performed. For example, the autonomous pentesting agent 105 may add fingerprints to the fingerprint database 435 (e.g., build out the fingerprint database 435) as asset types are identified during pentests. Additionally, the autonomous pentesting agent 105 may update existing fingerprints in the fingerprint database 435 as information is obtained via pentesting operations.

For example, the autonomous pentesting agent 105 may identify that the information 415 associated with the network asset 405 does not correspond to a fingerprint stored in the fingerprint database 435. In such examples, the autonomous pentesting agent 105 may add an entry to the fingerprint database including a new fingerprint corresponding to the information 415. The autonomous pentesting agent 105 may classify the network asset 405 using the information 415 and/or one or more open-source tools (e.g., Shodan). That is, the autonomous pentesting agent 105 may augment the information 415 identified via the pentesting operations 410-a to generate a fingerprint to be stored in the fingerprint database 435.

In some examples, the autonomous pentesting agent 105 may use the AI system 305 (or one or more LLMs of the AI system 305) to generate the fingerprint. For example, the AI system 305 may obtain the information 415 and identify patterns or RegExes within the information 415 that are indicative of an asset type. The AI system 305 may generate a fingerprint corresponding to the information 415 offline to build a fingerprint database 435, which may be used for future pentests. Accordingly, the AI system 305 may classify the network asset 405 after the autonomous pentest including the pentesting operations 410-a such that the classification does not delay the pentest, but the fingerprint may be used for subsequent pentests.

The AI system 305 may use the information 415 obtained during the pentest to obtain additional information indicative of the asset type 440 and generate the fingerprint. The AI system 305 may be an example of a retrieval augmented generation (RAG) system which may improve an accuracy of one or more LLMs by integrating external knowledge sources. In some examples, the AI system 305 (e.g., a RAG system) may index and store fingerprints, asset types, vulnerability information, and exploit information such that the autonomous pentesting agent 105 may retrieve and use such information during pentesting. The AI system 305 may include multiple agents, where each agent may perform a different task (e.g., classification, augmentation, exploit generation, reporting, etc.).

The AI system 305 may perform primary retrieval, supplemental retrieval, and vector retrieval as well as, in some examples, use heuristics to augment the information 415. The primary retrieval may involve use of an open-source tool, such as Shodan. For example, the AI system 305 may perform a search using the open-source tool to identify an asset type corresponding to the HTTP header(s) 420-a (or a different attribute) identified during the pentest. Specifically, the AI system 305 may use a Shodan Python software development kit (SDK) (or other public application programming interfaces (APIs)). The supplemental retrieval may involve obtaining additional information via external feeds such as ExploitDB, vendor vulnerability feeds, dark-web, or the like. The vector retrieval may involve querying a database (e.g., ChromaDB) with fingerprint embeddings or common platform enumeration (CPE) keywords. In some examples, the AI system 305 may also use heuristics, such as comma separated values (CSV) lookups, regex searches (e.g., based on titles or cookies), or CPE construction. The autonomous pentesting agent 105 may combine both the information 415 obtained during the pentest and the additional information obtained via the AI system 305 to generate the fingerprint (or classify the network asset 405). For example, the autonomous pentesting agent 105 may classify the network asset 405 via cluster analysis (e.g., based on a “cluster” including the information 415 and additional information).

Alternatively, the autonomous pentesting agent 105 may identify that the information 415 associated with the network asset 405 corresponds to the fingerprint 445 stored in the fingerprint database 435. For example, the autonomous pentesting agent 105 may identify a match between the HTTP header(s) 420-b, the HTML title(s) 425-b, and/or the version string(s) 430-b of the fingerprint 445 and corresponding parameters of the information 415. In such examples, the autonomous pentesting agent 105 may classify the network asset 405 as the asset type 440 based on the fingerprint 445 being mapped to the asset type 440.

In some examples, the autonomous pentesting agent 105 may classify the network asset 405 as the asset type 440 based on a confidence score. As an example, the autonomous pentesting agent 105 may generate a classification for the network asset 405 as the asset type 440 with a given confidence score. If the confidence score exceeds a threshold (such as 0.6, 0.7, 0.8 using a 0 to 1 scale), the autonomous pentesting agent 105 may proceed with developing and testing exploits corresponding to the asset type 440. The autonomous pentesting agent 105 may update the confidence score throughout the pentest. That is, the autonomous pentesting agent 105 may update the confidence score after using one or more open-source tools to obtain additional information, executing the exploits 350 corresponding to the asset type 440, or the like. For example, if an exploit is performed on an asset and fails, the confidence score may be decreased. If the exploit is performed on an asset and succeeds, information about the success may be stored and referenced later in the pentest (or in a subsequent pentest) for scoring other assets. That is, the confidence score of assets identified in the future may be based on the previous success or failure of an exploit.

Additionally, or alternatively, the autonomous pentesting agent 105 may classify the network asset 405 as the asset type 440 based on a favicon hash. For example, the autonomous pentesting agent 105 may use a neural network (e.g., a convolutional neural network (CNN)) of the AI system 305 to analyze a screenshot of an icon of the network asset 405 and, accordingly, identify that the network asset 405 is the asset type 440.

The AI system 305 may continuously update the fingerprint database 435 based on information obtained via pentesting operations. For example, the AI system 305 may build out the fingerprint database 435 during or after the autonomous pentest and/or over multiple autonomous pentests as information is gathered (e.g., more data used to generate the fingerprints is captured). As new asset types appear in autonomous pentests, the autonomous pentesting agent and/or the AI system 305 may refresh the fingerprint database 435, discover vulnerabilities associated with the new asset types, and recalibrate priority levels of different asset types. In such examples, the autonomous pentesting agent 105 may classify a broader range of network assets and/or classify network assets more accurately over time as more information is obtained, improving existing fingerprint information and cataloging additional fingerprints of additional asset types. Additionally, the AI system 305 may continuously update fingerprints in the fingerprint database 435. For example, the autonomous pentesting agent 105 may update the fingerprint 445 in the fingerprint database 435 to include information about the network asset 405 classified as the asset type 440—including updating the HTTP header(s), HTML title(s), or version string(s). Updating the fingerprint 445 may refer to adding additional information to the fingerprint 445, removing outdated information from the fingerprint 445, and/or replacing information in the fingerprint 445.

The autonomous pentesting agent 105 may associate one or more labels with the network asset 405 based on classifying the network asset 405 as the asset type 440. As an example, the autonomous pentesting agent 105 may identify that the network asset 405 is Microsoft Exchange. Accordingly, the autonomous pentesting agent 105 may associate corresponding labels with the network asset 405, such as “mail server” and “Windows.” The autonomous pentesting agent 105 may use the AI system 305 to assign the one or more labels to the network asset 405. For example, the AI system 305 may receive an input indicating that the network asset 405 is Microsoft Exchange and a request to generate a quantity of labels (e.g., top k labels) for the network asset 405. In such examples, the AI system 305 may generate labels based on information about Microsoft Exchange stored from previous pentests, obtained during pentesting, and/or via open-source tools.

In some examples, the asset type 440 may correspond to a predefined set of labels. That is, when the autonomous pentesting agent 105 identifies the network asset 405 as being the asset type 440, the autonomous pentesting agent 105 may automatically assign the predefined labels of the asset type 440 to the network asset 405. Additionally, or alternatively, the autonomous pentesting agent 105 may assign labels based on the pentesting information and/or information from open-source tools. That is, the autonomous pentesting agent 105 may determine or generate one or more labels corresponding to the asset type 440. As an example, the autonomous pentesting agent 105 may generate labels based on determining that the network asset 405 is Microsoft Exchange and that Microsoft Exchange is a mail service.

In some examples, the autonomous pentesting agent 105 may determine one or more functional classifications of the network asset 405 based on classifying the network asset 405 as the asset type 440. For example, the asset type 440 may correspond to one or more functional classifications indicative of capabilities of the asset type 440 (or the network asset 405) to perform operations within the target network. As an example, the autonomous pentesting agent 105 may determine that the network asset 405 functions as a domain controller, a database, a file server, or another function.

Additionally, or alternatively, the autonomous pentesting agent 105 may determine a priority level associated with the network asset 405. For example, the autonomous pentesting agent 105 may identify a priority level associated with the network asset 405 based on classifying the network asset 405 as the asset type 440 and/or based on the one or more functional classifications of the network asset 405. As an example, the autonomous pentesting agent 105 may assign a relatively high priority level to the network asset 405 based on the one or more functional classifications indicating a high-value function (a domain controller, a Virtual Private Network (VPN) server, a mail server, a file share, network devices, host-connected cloud services and cloud service connectors, on-premises identity management servers, on-premises endpoint detection and response (EDR) managers, etc.). The autonomous pentesting agent 105 may use the priority levels when performing subsequent pentesting operations and/or recommending remediation operations. That is, the autonomous pentesting agent 105 may prioritize network assets having relatively higher priority levels as targets for subsequent pentesting operations. Additionally, or alternatively, the autonomous pentesting agent 105 may prioritize information included in reports, such as identified vulnerabilities and associated remediation operation recommendations, according to the priority levels.

The autonomous pentesting agent 105 may associate the network asset 405 with one or more vulnerabilities based on classifying the network asset 405 as the asset type 440. For example, the autonomous pentesting agent 105 may identify one or more vulnerabilities (e.g., Common Vulnerabilities and Exposures (CVEs)) associated with the asset type 440. The autonomous pentesting agent 105 may monitor (e.g., in real-time or periodically) information from one or more data sources, including National Vulnerability Database (NVD) JavaScript Object Notation (JSON) feeds, Cybersecurity and Infrastructure Security Agency (CISA) Known Exploited Vulnerabilities (KEV) JSON feeds, vendor advisories, and pentesting data. The fingerprint database 435, a separate database, or a collection within a data store may store information about vulnerabilities associated with different asset types, including CVE information, Common Vulnerability Scoring System (CVSS) metrics, KEV flags, and indications of dates (when vulnerabilities “emerged” or were disclosed publicly).

Additionally, the autonomous pentesting agent 105 may identify exploits that target the one or more vulnerabilities associated with the asset type 440. Such exploits may be referred to as asset type-specific exploits, which may be different from baseline exploits used for the pentesting operations 410-a. For example, the asset type-specific exploits may target vulnerabilities or misconfigurations that are applicable to the asset type 440 that the network asset 405 is classified as. Such vulnerabilities or misconfigurations may be excluded from vulnerabilities targeted by the base set of pentesting operations, as the vulnerabilities or misconfigurations may be present across relatively few networks (e.g., present in 5% or fewer networks). As an example, asset-type specific exploits may target open-source applications, which may be manually configured or adjusted by users of the target network, thereby introducing vulnerabilities. For example, a user of the target network may modify an open-source application to use one or more application programming interface (API) keys to communicate with an AWS server, allowing an attacker to access the AWS server if a host having the open-source application is compromised. In the example of FIG. 4, the autonomous pentesting agent 105 may identify exploits 350 that target one or more vulnerabilities of the asset type 440.

The exploits 350 may include command-line configurations tailored to vulnerabilities of the asset type 440. For example, the exploits 350 may include one or more combinations (e.g., chains) of modules of executable code (e.g., Metasploit modules) including one or more arguments such as host addresses, ports, or other exploit parameters. In other words, the autonomous pentesting agent 105 may generate exploits 350 that include arguments specific to the asset type 440. The autonomous pentesting agent 105 may generate the exploits 350 after adding the fingerprint 445 to the fingerprint database 435, during a subsequent pentest, or between pentests (e.g., while offline). That is, the autonomous pentesting agent 105 may generate the exploits 350 based on information obtained via one or more first pentests and use the exploits 350 during one or more second pentests (e.g., subsequent pentests). Additionally, or alternatively, the autonomous pentesting agent 105 may identify the exploits 350 using open-source tools (e.g., an ExploitDB API, GitHub, etc.), internal databases (e.g., exploits identified through other pentests), or both. In some examples, the autonomous pentesting agent 105 may generate commands corresponding to the exploits 350 (e.g., executable code) using the AI system 305. For example, the autonomous pentesting agent 105 may input a prompt to the AI system 305 including an indication of the asset type 440 (e.g., a CPE), a CVE, fingerprint context, and exploit template libraries. The AI system 305 may generate the commands (e.g., Metasploit, client URL (cURL), custom scripts) with placeholders based on the prompt.

The autonomous pentesting agent 105 may store the exploits 350 in the fingerprint database 435 such that, when a network asset of the asset type 440 is identified, the autonomous pentesting agent 105 may use the exploits 350 to target vulnerabilities of the network asset (e.g., without generating custom exploits for each network asset during each pentest). For example, the AI system 305 may index and store the exploits 350 in the fingerprint database 435 and retrieve exploit(s) (e.g., via the RAG system) when a network asset of the asset type 440 is identified based on a ranking logic (e.g., prioritize or rank exploits associated with the asset type 440 based on CVSS, KEV status, exploit activity, semantic relevance, etc.). That is, the autonomous pentesting agent 105 may retrieve a ranked list of the exploits 350 associated with the asset type 440. The exploits 350 may be ranked according to a success rate (e.g., a first listed exploit may be associated with a highest quantity of successful executions, a second listed exploit a second highest quantity of successful executions, and so on).

As an example, the autonomous pentesting agent 105 may generate exploits 350 that include using default login combinations for different software. That is, the autonomous pentesting agent 105 may identify a default login combination associated with the asset type 440 and, accordingly, include an exploit in which the autonomous pentesting agent 105 attempts to use the default login combination in the exploits 350 mapped to the asset type 440.

In some examples, the autonomous pentesting agent 105 may determine a safety level of the exploits 350 before storing the exploits 350 in the fingerprint database 435 and/or using the exploits 350 during a pentest. For example, the autonomous pentesting agent 105 may generate the exploits 350 (e.g., using the AI system 305) and output the exploits 350 to be manually reviewed (e.g., by a human). A human reviewer may validate whether the exploits 350 are safe to execute on a network (e.g., verify an environmental impact of the exploits 350), ensuring that the exploits 350 are in accordance with one or more pentesting or data security policies of the target network and that the exploits 350 may be performed without degrading user experience of users of the target network (e.g., without locking users out of network assets, exposing sensitive data, etc.). The autonomous pentesting agent 105 may receive one or more inputs indicative of authorization to use the exploits 350 during a pentest.

Additionally, or alternatively, the autonomous pentesting agent 105 may test the exploits 350 in a sandbox environment. For example, the autonomous pentesting agent 105 may execute commands output by the AI system 305 in a sandbox environment and capture system outputs (standard output (stdout), standard error (stderr), etc.). The AI system 305 may analyze the outputs (e.g., execution traces) and, if applicable, suggest modifications to the commands. The AI system 305 may iteratively execute and refine the commands until a criteria is met (e.g., a threshold stdout or stderr) or until a threshold quantity of iterations are performed.

The autonomous pentesting agent 105 may use the exploits 350 in pentesting operations 410-b. The pentesting operations 410-b may be specific to the asset type 440 and be different from the pentesting operations 410-a of the base set of pentesting operations. In other words, the autonomous pentesting agent 105 may perform pentesting operations that target vulnerabilities of the asset type 440 associated with the network asset 405. The autonomous pentesting agent 105 may retrieve and use the exploits 350 based on classifying the network asset 405 as the asset type 440 during the pentest. In some examples, the autonomous pentesting agent 105 may use the exploits 350 based on a vulnerability score threshold (e.g., a CVSS, a KEV score, etc.) or risk scoring threshold (e.g., based on a priority level of the network asset 405 and network assets accessible through the network asset 405, such as in attack paths or according to a function of the network asset 405). By using the exploits 350 associated with the asset type 440 in addition to the base set of pentesting operations, the autonomous pentesting agent 105 may identify vulnerabilities of network assets of the target network in a more comprehensive manner.

While a single network asset and asset type are illustrated with respect to FIG. 4, it is understood that the pentesting operations 410-a may identify and obtain information associated with multiple network assets, and the fingerprint database 435 may include any number of mappings of fingerprints, asset types, and exploits.

The autonomous pentesting agent 105 may output a report based on the autonomous pentest that includes the pentesting operations 410-a and the pentesting operations 410-b. The report may indicate fingerprints generated during the autonomous pentest, corresponding asset types (e.g., CPEs), a vulnerability risk profile of each network asset, exploit candidates and associated sources (e.g., AI-generated, obtained from an open-source tool, etc.), generated commands and execution outcomes, and remediation recommendations, among other information. In some examples, the autonomous pentesting agent 105 may output the report using the AI system 305, and the report may be provided to a user associated with the target network or an autonomous pentesting service associated with the autonomous pentesting agent 105 and/or the AI system 305.

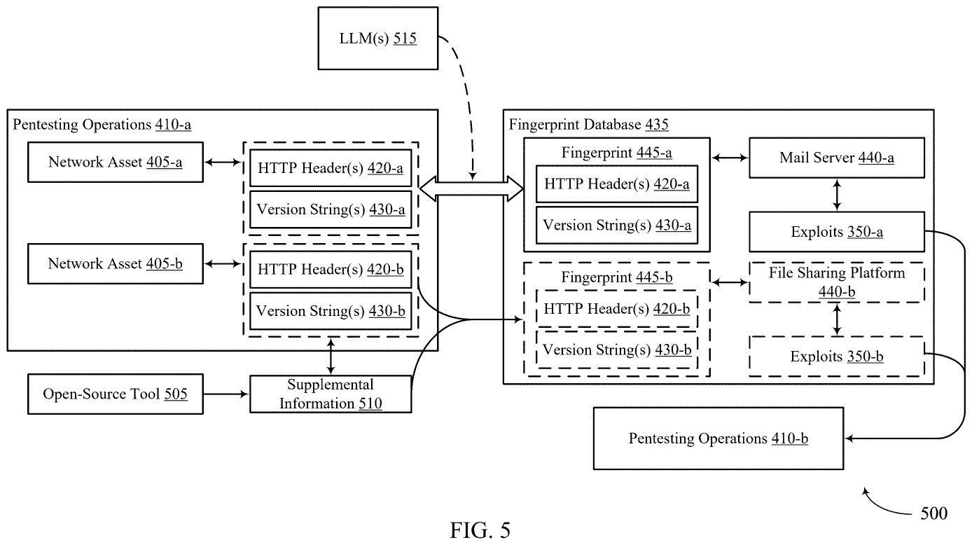

FIG. 5 shows an example of a computing environment 500 that supports automated network asset classification in autonomous pentesting in accordance with aspects of the present disclosure. The computing environment 500 may implement or be implemented by the computing environment 100, the autonomous pentest map 200, the computing environment 300, the computing environment 400, or any combination thereof. For example, the computing environment 500 may illustrate an autonomous pentest of a target network in which an autonomous pentesting agent performs asset type-specific exploits based on network asset classifications.

An autonomous pentesting agent may perform pentesting operations 410-a during an autonomous pentest. The pentesting operations 410-a may be baseline pentesting operations selected from a base set of pentesting operations. For example, the pentesting operations 410-a may include a scan (e.g., crawl) of the target network in which the autonomous pentesting agent 105 identifies a network asset 405-a and a network asset 405-b as well as information associated with each of the network assets. For example, the autonomous pentesting agent may identify HTTP header(s) 420-a and version string(s) 430-a associated with the network asset 405-a and HTTP header(s) 420-b and version string(s) 430-b associated with the network asset 405-b.

The autonomous pentesting agent may use LLM(s) 515 to classify the network assets as asset types. For example, the autonomous pentesting agent, using the LLM(s) 515, may classify the network asset 405-a as a mail server 440-a based on matching the information associated with the network asset 405-b obtained via the pentesting operations 410-a to a fingerprint 445-a mapped to the mail server 440-a. That is, the autonomous pentesting agent may identify that the fingerprint 445-a includes HTTP header(s) 420-a and version string(s) 430-a that are the same as those identified during the pentesting operations 410-a for the network asset 405-a.

The autonomous pentesting agent may use the LLM(s) 515 to identify that the information associated with the network asset 405-b does not correspond to fingerprints included in the fingerprint database 435. In such examples, the autonomous pentesting agent may generate and store a fingerprint 445-b corresponding to the network asset 405-b in the fingerprint database 435. That is, the autonomous pentesting agent may determine that the network asset 405-b is a file sharing platform 440-b and update the fingerprint database 435 to include a mapping between a fingerprint 445-b (including the HTTP header(s) 420-b and version string(s) 430-b identified during the pentesting operations 410-a) and the file sharing platform 440-b. In some examples, the autonomous pentesting agent may use an open-source tool 505 to obtain supplemental information 510 associated with the network asset 405-b and/or determine that the network asset 405-b is the file sharing platform 440-b. In such examples, the autonomous pentesting agent may include the supplemental information 510 in the fingerprint 445-b.

The autonomous pentesting agent may generate exploits 350-b corresponding to the file sharing platform 440-b based on adding the file sharing platform 440-b to the fingerprint database 435. For example, the autonomous pentesting agent may identify (e.g., using the open-source tool 505) default login credentials for the file sharing platform 440-b and include the default login credentials in the exploits 350-b.

The autonomous pentesting agent may use exploits 350-a and exploits 350-b mapped to the mail server 440-a and the file sharing platform 440-b, respectively, in pentesting operations 410-b after the pentesting operations 410-a. For example, the autonomous pentesting agent may attempt to use the default login credentials for the file sharing platform 440-b.

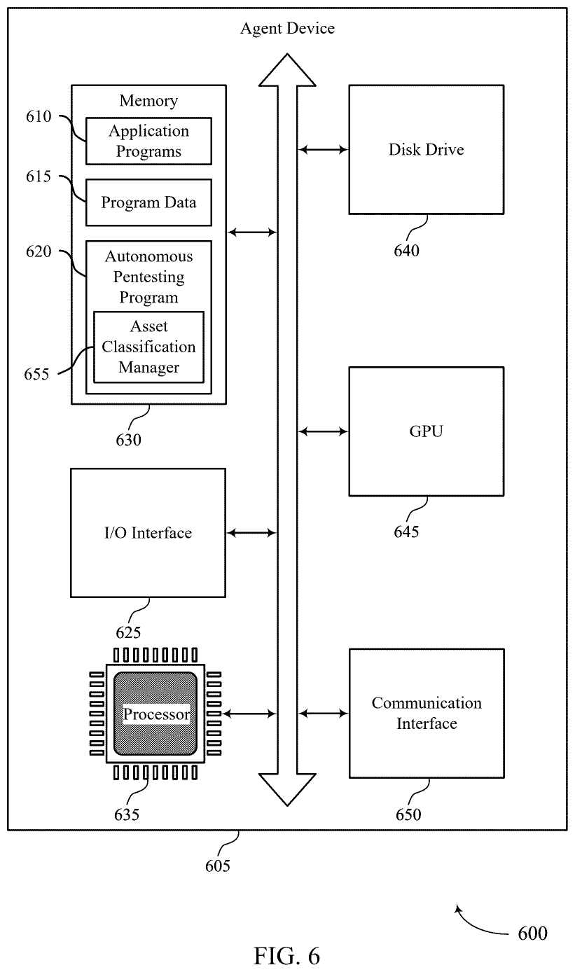

FIG. 6 shows a diagram of a system 600 including an agent device 605 that supports automated network asset classification in autonomous pentesting in accordance with aspects of the present disclosure. The agent device 605 may be an example of a device or server on which an autonomous pentesting agent 105 is deployed as described herein. The agent device 605 may include components for automated network asset classification in autonomous pentesting, such as a memory 630 including application programs 610, program data 615, an autonomous pentesting program 620, and a asset classification manager 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting automated network asset classification in autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting automated network asset classification in autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a target network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest involving autonomous pentesting using network asset classifications.

The asset classification manager 655 may support autonomous pentesting using network asset classifications in accordance with examples as disclosed herein. For example, the asset classification manager 655 may be configured as or otherwise support a means for performing, during an autonomous pentest of a network including multiple network assets, one or more baseline pentesting operations selected from a base set of autonomous pentesting operations. The asset classification manager 655 may be configured as or otherwise support a means for obtaining, during the autonomous pentest, information associated with a network asset of the multiple network assets based on the one or more baseline pentesting operations. The asset classification manager 655 may be configured as or otherwise support a means for classifying the network asset as a first asset type based on the information obtained during the autonomous pentest and on a mapping between multiple asset types and multiple fingerprints, where each fingerprint of the multiple fingerprints includes fingerprint information specific to a respective asset type and obtained via at least one baseline pentesting operation of the base set of autonomous pentesting operations. The asset classification manager 655 may be configured as or otherwise support a means for performing, during the autonomous pentest of the network, one or more additional pentesting operations selected from a set of autonomous pentesting operations specific to the first asset type and different from the base set of autonomous pentesting operations, where the one or more additional pentesting operations target one or more security vulnerabilities associated with the first asset type.

By including or configuring the asset classification manager 655 in accordance with examples as described herein, the agent device 605 may support techniques for improved network security.

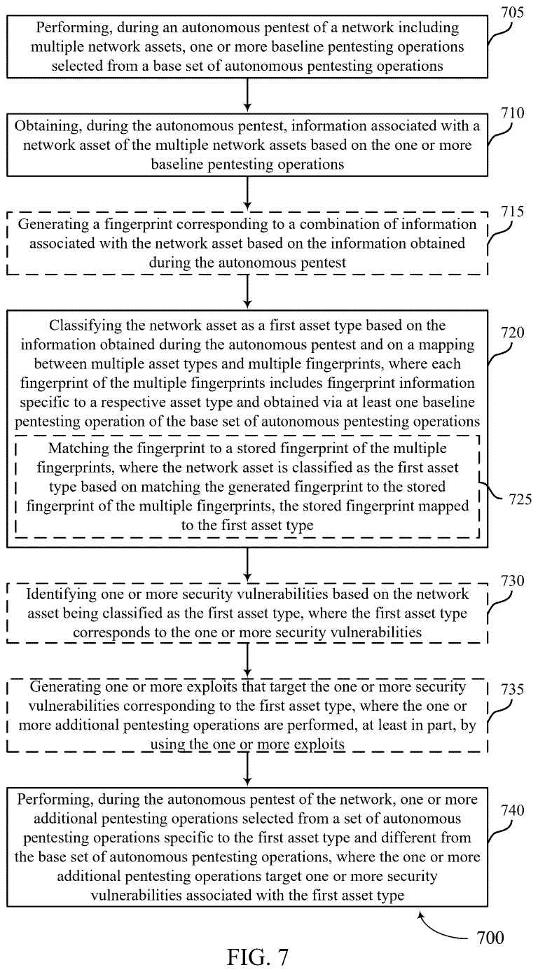

FIG. 7 shows a flowchart illustrating a method 700 that supports automated network asset classification in autonomous pentesting in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method 700 may include Performing, during an autonomous pentest of a network including multiple network assets, one or more baseline pentesting operations selected from a base set of autonomous pentesting operations

At 710, the method 700 may include obtaining, during the autonomous pentest, information associated with a network asset of the multiple network assets based on the one or more baseline pentesting operations.

At 715, the method 700 may include generating a fingerprint corresponding to a combination of information associated with the network asset based on the information obtained during the autonomous pentest.

At 720, the method 700 may include classifying the network asset as a first asset type based on the information obtained during the autonomous pentest and on a mapping between multiple asset types and multiple fingerprints, where each fingerprint of the multiple fingerprints includes fingerprint information specific to a respective asset type and obtained via at least one baseline pentesting operation of the base set of autonomous pentesting operations.

At 725, classifying the network asset may include matching the fingerprint to a stored fingerprint of the multiple fingerprints, where the network asset is classified as the first asset type based on matching the generated fingerprint to the stored fingerprint of the multiple fingerprints, the stored fingerprint mapped to the first asset type.

At 730, the method 700 may include identifying one or more security vulnerabilities based on the network asset being classified as the first asset type, where the first asset type corresponds to the one or more security vulnerabilities.

At 735, the method 700 may include generating one or more exploits that target the one or more security vulnerabilities corresponding to the first asset type, where the one or more additional pentesting operations are performed, at least in part, by using the one or more exploits.

At 740, the method 700 may include performing, during the autonomous pentest of the network, one or more additional pentesting operations selected from a set of autonomous pentesting operations specific to the first asset type and different from the base set of autonomous pentesting operations, where the one or more additional pentesting operations target one or more security vulnerabilities associated with the first asset type.

The following provides an overview of aspects of the present disclosure:

Aspect 1: A method for autonomous pentesting using network asset classifications comprising: performing, during an autonomous pentest of a network comprising a plurality of network assets, one or more baseline pentesting operations selected from a base set of autonomous pentesting operations; obtaining, during the autonomous pentest, information associated with a network asset of the plurality of network assets based at least in part on the one or more baseline pentesting operations; classifying the network asset as a first asset type based at least in part on the information obtained during the autonomous pentest and on a mapping between a plurality of asset types and a plurality of fingerprints, wherein each fingerprint of the plurality of fingerprints comprises fingerprint information specific to a respective asset type and obtained via at least one baseline pentesting operation of the base set of autonomous pentesting operations; and performing, during the autonomous pentest of the network, one or more additional pentesting operations selected from a set of autonomous pentesting operations specific to the first asset type and different from the base set of autonomous pentesting operations, wherein the one or more additional pentesting operations target one or more security vulnerabilities associated with the first asset type.

Aspect 2: The method of aspect 1, further comprising: identifying the one or more security vulnerabilities based at least in part on the network asset being classified as the first asset type, wherein the first asset type corresponds to the one or more security vulnerabilities.

Aspect 3: The method of aspect 2, further comprising: generating one or more exploits that target the one or more security vulnerabilities corresponding to the first asset type, wherein the one or more additional pentesting operations are performed, at least in part, by using the one or more exploits.

Aspect 4: The method of aspect 3, further comprising: storing the one or more exploits that target the one or more security vulnerabilities corresponding to the first asset type, wherein the one or more exploits are mapped to the first asset type and a fingerprint of the plurality of fingerprints associated with the first asset type.

Aspect 5: The method of aspect 4, further comprising: performing, during a second autonomous pentest of the network and based at least in part on the one or more exploits being stored, the one or more exploits that target a second network asset based at least in part on classification of the second network asset as the first asset type.

Aspect 6: The method of any of aspects 3 through 5, wherein generating the one or more exploits comprises: obtaining respective combinations of modules of executable code corresponding to each exploit of the one or more exploits, wherein each module of the respective combinations of modules comprises one or more arguments, the one or more arguments comprising one or more host addresses, ports, exploit parameters, or any combination thereof.

Aspect 7: The method of any of aspects 3 through 6, further comprising: performing the one or more exploits in a sandbox environment isolated from the network; and updating one or more parameters of the one or more exploits in accordance with one or more system outputs captured after performance of the one or more exploits in the sandbox environment, wherein storing the one or more exploits further comprises: storing an indication of the one or more system outputs.

Aspect 8: The method of any of aspects 1 through 7, further comprising: generating a fingerprint corresponding to a combination of information associated with the network asset based at least in part on the information obtained during the autonomous pentest.

Aspect 9: The method of aspect 8, further comprising: identifying an absence of the fingerprint of the network asset from the plurality of fingerprints of the mapping between the plurality of asset types and the plurality of fingerprints; determining the first asset type corresponding to the fingerprint based at least in part on the information associated with the network asset obtained during the autonomous pentest, supplemental information obtained via one or more open-source tools, or both; and updating the mapping to include the first asset type and the fingerprint based at least in part on the absence of the fingerprint from the mapping.

Aspect 10: The method of any of aspects 8 through 9, further comprising: matching the fingerprint to a stored fingerprint of the plurality of fingerprints, wherein the network asset is classified as the first asset type based at least in part on matching the generated fingerprint to the stored fingerprint of the plurality of fingerprints, the stored fingerprint mapped to the first asset type.

Aspect 11: The method of aspect 10, further comprising: updating the stored fingerprint of the plurality of fingerprints based at least in part on the information obtained during the autonomous pentest.

Aspect 12: The method of any of aspects 1 through 11, further comprising: collecting, via one or more open-source tools, supplementary information associated with the network asset based at least in part on the information obtained via the one or more baseline pentesting operations, wherein the network asset is classified based at least in part on the information and the supplementary information.

Aspect 13: The method of any of aspects 1 through 12, wherein classifying the network asset comprises: determining one or more functional classifications of the network asset, the one or more functional classifications indicative of capabilities of the network asset to perform one or more operations within the network, wherein the one or more additional pentesting operations use the capabilities of the network asset to perform the one or more operations within the network in accordance with the one or more functional classifications.

Aspect 14: The method of any of aspects 1 through 13, further comprising: obtaining a set of default login credentials associated with the first asset type of the plurality of asset types, wherein the one or more additional pentesting operations selected from the set of autonomous pentesting operations specific to the first asset type comprise use of the set of default login credentials at the network asset classified as the first asset type.

Aspect 15: The method of any of aspects 1 through 14, wherein the plurality of asset types are associated with a plurality of priority levels corresponding to a respective function within the network of respective asset types, and wherein the one or more additional pentesting operations are performed in accordance with a priority level of the plurality of priority levels corresponding to a function of the first asset type.

Aspect 16: The method of any of aspects 1 through 15, further comprising: outputting a security assessment report comprising an indication of the information associated with the network asset obtained during the autonomous pentest, one or more recommendations associated with the network asset, or both, wherein the security assessment report is sorted in accordance with the priority level.

Aspect 17: The method of any of aspects 1 through 16, wherein the information associated with the network asset obtained during the autonomous pentest comprises one or more of: a HTTL header, a HTML title, a version string, or any combination thereof.

Aspect 18: The method of any of aspects 1 through 17, wherein performing the one or more baseline pentesting operations comprises: performing a scan of the network, wherein the scan identifies a presence of the plurality of network assets within the network, and wherein the information associated with the network asset is obtained after the network asset is identified via the scan.

Aspect 19: An apparatus for autonomous pentesting using network asset classifications, comprising: one or more memories storing processor-executable code; and one or more processors coupled with the one or more memories and individually or collectively operable to execute the code to cause the apparatus to perform a method of any of aspects 1 through 18.

Aspect 20: A non-transitory computer-readable medium storing code for autonomous pentesting using network asset classifications, the code comprising instructions executable by one or more processors to perform a method of any of aspects 1 through 18.

Aspect 21: An apparatus for autonomous pentesting using network asset classifications, comprising at least one means for performing a method of any aspects 1 through 18.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for autonomous pentesting using network asset classifications comprising:
performing, during an autonomous pentest of a network comprising a plurality of network assets, one or more baseline pentesting operations selected from a base set of autonomous pentesting operations;
obtaining, during the autonomous pentest, information associated with a network asset of the plurality of network assets based at least in part on the one or more baseline pentesting operations;
classifying the network asset as a first asset type based at least in part on the information obtained during the autonomous pentest and on a mapping between a plurality of asset types and a plurality of fingerprints, wherein each fingerprint of the plurality of fingerprints comprises fingerprint information specific to a respective asset type and obtained via at least one baseline pentesting operation of the base set of autonomous pentesting operations; and
performing, during the autonomous pentest of the network, one or more additional pentesting operations selected from a set of autonomous pentesting operations specific to the first asset type and different from the base set of autonomous pentesting operations, wherein the one or more additional pentesting operations target one or more security vulnerabilities associated with the first asset type.

2. The method of claim 1, further comprising:
identifying the one or more security vulnerabilities based at least in part on the network asset being classified as the first asset type, wherein the first asset type corresponds to the one or more security vulnerabilities.

3. The method of claim 2, further comprising:
generating one or more exploits that target the one or more security vulnerabilities corresponding to the first asset type, wherein the one or more additional pentesting operations are performed, at least in part, by using the one or more exploits.

4. The method of claim 3, further comprising:
storing the one or more exploits that target the one or more security vulnerabilities corresponding to the first asset type, wherein the one or more exploits are mapped to the first asset type and a fingerprint of the plurality of fingerprints, the fingerprint associated with the first asset type.

5. The method of claim 4, further comprising:
performing, during a second autonomous pentest of the network and based at least in part on the one or more exploits being stored, the one or more exploits that target a second network asset based at least in part on classification of the second network asset as the first asset type.

6. The method of claim 3, wherein generating the one or more exploits comprises:
obtaining respective combinations of modules of executable code corresponding to each exploit of the one or more exploits, wherein each module of the respective combinations of modules comprises one or more arguments, the one or more arguments comprising one or more host addresses, ports, exploit parameters, or any combination thereof.

7. The method of claim 3, further comprising:
performing the one or more exploits in a sandbox environment isolated from the network; and
updating one or more parameters of the one or more exploits in accordance with one or more system outputs captured after performance of the one or more exploits in the sandbox environment; and
storing an indication of the one or more system outputs.

8. The method of claim 1, further comprising:
generating a fingerprint corresponding to a combination of information associated with the network asset based at least in part on the information obtained during the autonomous pentest.

9. The method of claim 8, further comprising:
identifying an absence of the fingerprint of the network asset from the plurality of fingerprints of the mapping between the plurality of asset types and the plurality of fingerprints;
determining the first asset type corresponding to the fingerprint based at least in part on the information associated with the network asset obtained during the autonomous pentest, supplemental information obtained via one or more open-source tools, or both; and
updating the mapping to include the first asset type and the fingerprint based at least in part on the absence of the fingerprint from the mapping.

10. The method of claim 8, further comprising:
matching the fingerprint to a stored fingerprint of the plurality of fingerprints, wherein the network asset is classified as the first asset type based at least in part on matching the generated fingerprint to the stored fingerprint of the plurality of fingerprints, the stored fingerprint mapped to the first asset type.

11. The method of claim 10, further comprising:
updating the stored fingerprint of the plurality of fingerprints based at least in part on the information obtained during the autonomous pentest.

12. The method of claim 1, further comprising:
collecting, via one or more open-source tools, supplementary information associated with the network asset based at least in part on the information obtained via the one or more baseline pentesting operations, wherein the network asset is classified based at least in part on the information and the supplementary information.

13. The method of claim 1, wherein classifying the network asset comprises:
determining one or more functional classifications of the network asset, the one or more functional classifications indicative of capabilities of the network asset to perform one or more operations within the network, wherein the one or more additional pentesting operations use the capabilities of the network asset to perform the one or more operations within the network in accordance with the one or more functional classifications.

14. The method of claim 1, further comprising:
obtaining a set of default login credentials associated with the first asset type of the plurality of asset types, wherein the one or more additional pentesting operations selected from the set of autonomous pentesting operations specific to the first asset type comprise use of the set of default login credentials at the network asset classified as the first asset type.

15. The method of claim 1, wherein the plurality of asset types are associated with a plurality of priority levels corresponding to a respective function within the network of respective asset types, and wherein the one or more additional pentesting operations are performed in accordance with a priority level of the plurality of priority levels corresponding to a function of the first asset type.

16. The method of claim 15, further comprising:
outputting a security assessment report comprising an indication of the information associated with the network asset obtained during the autonomous pentest, one or more recommendations associated with the network asset, or both, wherein the security assessment report is sorted in accordance with the priority level.

17. The method of claim 1, wherein the information associated with the network asset obtained during the autonomous pentest comprises one or more of: a Hypertext Transfer Protocol (HTTP) header, a Hypertext Markup Language (HTML) title, a version string, a favorite icon (favicon) hash, a favicon screenshot, an HTML body hash, a Secure Sockets Layer (SSL) fingerprint, a cookie signature, a source HTML, or any combination thereof.

18. The method of claim 1, wherein performing the one or more baseline pentesting operations comprises:
performing a scan of the network, wherein the scan identifies a presence of the plurality of network assets within the network, and wherein the information associated with the network asset is obtained after the network asset is identified via the scan.

19. An apparatus for autonomous pentesting using network asset classifications, comprising:
one or more memories storing processor-executable code; and
one or more processors coupled with the one or more memories and individually or collectively operable to execute the code to cause the apparatus to:
perform, during an autonomous pentest of a network comprising a plurality of network assets, one or more baseline pentesting operations selected from a base set of autonomous pentesting operations;
obtain, during the autonomous pentest, information associated with a network asset of the plurality of network assets based at least in part on the one or more baseline pentesting operations;
classify the network asset as a first asset type based at least in part on the information obtained during the autonomous pentest and on a mapping between a plurality of asset types and a plurality of fingerprints, wherein each fingerprint of the plurality of fingerprints comprises fingerprint information specific to a respective asset type and obtained via at least one baseline pentesting operation of the base set of autonomous pentesting operations; and
perform, during the autonomous pentest of the network, one or more additional pentesting operations selected from a set of autonomous pentesting operations specific to the first asset type and different from the base set of autonomous pentesting operations, wherein the one or more additional pentesting operations target one or more security vulnerabilities associated with the first asset type.

20. A non-transitory computer-readable medium storing code for autonomous pentesting using network asset classifications, the code comprising instructions executable by one or more processors to:
perform, during an autonomous pentest of a network comprising a plurality of network assets, one or more baseline pentesting operations selected from a base set of autonomous pentesting operations;
obtain, during the autonomous pentest, information associated with a network asset of the plurality of network assets based at least in part on the one or more baseline pentesting operations;
classify the network asset as a first asset type based at least in part on the information obtained during the autonomous pentest and on a mapping between a plurality of asset types and a plurality of fingerprints, wherein each fingerprint of the plurality of fingerprints comprises fingerprint information specific to a respective asset type and obtained via at least one baseline pentesting operation of the base set of autonomous pentesting operations; and
perform, during the autonomous pentest of the network, one or more additional pentesting operations selected from a set of autonomous pentesting operations specific to the first asset type and different from the base set of autonomous pentesting operations, wherein the one or more additional pentesting operations target one or more security vulnerabilities associated with the first asset type.
